(19) United States
(12) Patent Application Publication
(10) Pub. No.: US 2016/0162647 A1
(43) Pub. Date: Jun. 9, 2016

(54) System for Processing Medical Operational Performance Information and Root Causes Thereof

(71) Applicant: analyticsMD, Inc., Mountain View, CA (US)

(72) Inventors: Ian Christopher, Mountain View, CA (US); Mudit Garg, Mountain View, CA (US); Brent Newhouse, Mountain View, CA (US)

(73) Assignee: analyticsMD, Inc., Mountain View, CA (US)

(21) Appl. No.: 14/562,626

(22) Filed: Dec. 5, 2014

(51) Int. Cl. G06F 19/00

(52) U.S. Cl. CPC G06F 19/327; G06F 19/322

(57) ABSTRACT

A system for analyzing medical operational performance information comprising: defining a set of operational performance metrics relevant to a medical treatment setting, determining the value of one or more members of the set of operational performance metrics based on information from one or more data sources, determining an expected value for the operational performance metric, associating a set of potential correlational factors or root causes with each operational performance metric; and determining the significance of the correlational factors or root causes on the deviation of the operational performance metric from its expected value by applying standard statistical methods.

### CROSS-REFERENCE TO RELATED APPLICATIONS

No related Applications

### STATEMENT REGARDING FEDERALLY SPONSORED RESEARCH OR DEVELOPMENT

Not Applicable

### TECHNICAL FIELD

The invention relates to a system for processing and displaying information about measures of operational performance in medical treatment settings and identifying causes or factors correlated with deviations in operational performance.

### BACKGROUND OF THE INVENTION

Managers, doctors, and other professionals in medical treatment settings, such as hospital departments (e.g., emergency department, operating room, intensive care unit), outpatient clients, and dental offices, face difficulties in monitoring, analyzing, and improving operational performance. While specific measures of operational performance vary across different medical treatment settings, in general operational performance measures are those measures that medical providers or other interested parties, such as administrators, insurance providers, or researchers, consider relevant to the quality, efficiency, or effectiveness of medical care. Operational performance measures typically concern measures of quality, efficiency, or effectiveness, such as average patient wait time, average treatment time, cost of treatment, percent of successful outcomes, length of patient stay, number of patients treated, or other metrics of interest to personnel concerned with the provision or analysis of medical care. In order to efficiently and effectively allocate resources and provide care, it is important for managers and medical personnel to be able to monitor operational performance and identify causes underlying deviations in operational performance in a timely manner.

Medical providers have traditionally had to obtain and manually review information from a variety of sources to monitor operational performance, including patient medical records, facilities reports, staffing information, and relevant baseline or contextual data (e.g., standard cost for patients undergoing an appendectomy or average wait time for the emergency room on a weekday morning). Such information can be used to determine whether care and treatment are being provided effectively and efficiently, and it can also be used to assess, and ultimately remedy, the factors or causes that contribute to deviations in expected operational performance.

Collecting, interpreting, and analyzing information relevant to one or more measures of operational performance and identifying the underlying factors or causes that contribute to deviations in expected operational performance, such as differential staffing levels, personnel assignments, methods of treatment, average patient age, acuity of conditions treated, available beds, turnaround of laboratory results, etc., and then communicating the results to staff members in a meaningful way can be a complex and burdensome process. As a result, too few managers actually undertake the work required to evaluate operational performance measures and to ascertain the causes behind deviations in expected or desired operational performance.

The system of the present invention is designed to streamline the process of collecting, processing, analyzing, displaying, and communicating operational performance information and the factors or causes that influence operational performance. The system gives medical professionals the ability to efficiently track operational performance and to identify factors that explain or correlate with changes in operational performance.

### SUMMARY OF THE INVENTION

The increasing adoption of electronic medical records (EMR) offers an array of novel opportunities for data analysis and analytics of interest to medical treatment providers, insurers, researchers, and government agencies to discover information useful for evaluating and improving medical treatment and care. By drawing on EMR and other data sources associated with the provision of medical care, the present invention provides doctors, administrators, and other professionals the ability to monitor operational performance and to identify factors responsible for changes in operational performance.

The system of the present invention interfaces with electronic medical records and other data sources, such as hospital records and internet data sources, to acquire information relevant to one or more operational performance measures, processes the information (either as a raw measure of operational performance or as an input to a calculated measure of operational performance) to determine the value of the operational performance measure, analyzes the influence of factors that correlate or co-vary with that operational performance measure, and identifies those factors with the most significant probabilistic influence on the deviation of operational performance measure from an expected or baseline value.

In one embodiment, a user of the system of the present invention first selects a measure of operational performance from the input screen, and the system displays or calculates the value of the selected operational performance measure from one or more data sources and displays the value to the user, typically with regard to a particular time settings and user interests, and the system of the present invention can be adapted to process and display a variety of operational performance measures depending on the interest of the user and available data sources. In one version of the present invention, the system is embodied in a software program that obtains information, via direct interface or manual input, from one or more sources of potentially relevant medical information, such as patient EMRs and hospital staffing records. The information obtained may consist of unitary or aggregate information that is constitutive of or relevant to One or more measure of operational performance.

Once the value of the operational performance measure or ‘metric’ selected by the user has been processed, the system of the present invention affords the user the ability to perform a so-called ‘root cause’ analysis, where the system identifies those factors or ‘root causes’ that have the strongest statistical relationship with (and thus, in a broad sense, explain) deviations of the operational metric from an expected value. The root cause analysis system represents a novel approach to data analytics that permits the rapid identification of causes or factors correlated with deviations in operational performance.

In the system of the present invention, each operational performance metric available for review is associated with an expected value. Depending on the interests of the user and the operational performance metric under consideration, the expected value of the metric can be determined in a number of ways. For example, the expected value of a metric can be determined based on its historical value, or derived from a set of variables that typically influence (in a linear or nonlinear manner) the value of the operational metric, or the expected value can simply be set as a baseline or ‘goal’ value.

For example, the expected value for the operational performance metric “wait time to see doctor” for an emergency room could be generated based on the average wait time for patients during the same time period (e.g., morning, afternoon, evening, late night) and/or the same day of the week over the prior year or time frame. Or, the expected value of the operational performance metric could be derived from a set of relevant factors, such as the number of doctors on duty, the number of patients, the average condition of patients, and other factors potentially relevant to the value of a particular metric. When the expected value is derived in this manner, potentially relevant factors are identified in advance by the party that configures or administrates the system. The contribution of each potentially relevant factor is typically determined by statistically estimating the best relationship (linear or non-linear mathematical transformation) for each factor in relation to the target metric based on historical data. Once the relationship of each factor with regard to the operational performance metric has been established, the system determines the expected value of the operational performance metric by adding each factor based on its magnitude and the extent to which it contributes to the value of the operational performance metric. A third alternative is for the expected value of the operational performance metric to be specified as a baseline or goal value. For example, the expected value of the “Wait Time to See Doctor” operational performance metric may simply be set at one hour to represent the unit's goal of maintaining an average wait time under an hour

While it is useful for medical personnel to conveniently and rapidly obtain the values of measures of operational performance and to view them in relation to expected values, the system of the present invention further provides users the ability to isolate those factors or ‘root causes’ that have the strongest statistical relationship with deviations in operational performance from expected values. This ‘root cause’ analysis framework gives medical personnel and managers the ability to readily ascertain, communicate, and address those causes or factors most responsible for deviations, positive or negative, in operational performance.

The root cause analysis framework is related to the operational performance system. Each measure of operational performance has its own set of potentially relevant factors or ‘root causes’ likely to co-vary with or ‘explain’ deviations in operational performance. A set of potential ‘root causes’ is configured in the system for each operational performance metric based on those causes or factors (for which a source of data is available that may affect the value of the operational performance metric. For example, the operational metric ‘Admitted Patient's Length of Stay’ in the emergency room ill be a function of a multiple underlying factors or causes that typically vary in that treatment setting, including but not limited to: wait to be seen by a physician, whether laboratory tests are ordered, whether radiology tests are ordered, the turnaround time for such tests, whether a specialist, such as a psychiatrist, is required to consult regarding a case, etc. Each of these elements is a potential factor or ‘root cause’ that may contribute to the operational performance measure, e.g., ‘Admitted Patient's Length of Stay,’ and the deviation of that measure from its expected value.

At the technical level, the root causes that potentially correlate with a given operational performance measure are configured in the system and populated by data from EMRs or other sources. In general, potential root causes are those factors likely to influence one or more operational performance measures in a particular medical treatment setting. The set of potential root causes associated with an operational performance metric will depend in part on the particular medical treatment setting, including the staffing, organization, workflow, and modalities of care. Additionally, to act as a root cause in the system of the present invention, information must not only be relevant to an operational performance metric, it must also be captured in some manner. Thus, for example, if a given treatment setting does not commonly scan or record the time from check in to seeing a doctor, then that information would not be available for root cause analysis. One of the advantages of the system of the present invention is that it encourages the acquisition of information relevant to operational performance.

While there are common data sources and causal factors present across medical treatment settings of the same general type, for optimal performance the system of the present invention is configured for particular treatment setting based on its workflow, relevant factors that vary among patients, and data sources available in that setting. That is, the set of ‘root causes’ potentially relevant to a given operational performance measure is relative to the particular medical treatment setting for which the system is configured, and the specific configuration depends in part on an appreciation of those factors that potentially correlate with the operational performance measure for that setting as well as the sources of relevant data. The present invention is thus directed to a general framework for the presentation and analysis of operational performance information in medical treatment settings that is configurable with regard to particular medical treatment settings.

Once a set of potential root causes has been identified with regard to a given operational performance measure, the system of the present invention can be used to evaluate the influence of each of the members of the set of potential root causes on that performance measure's deviation from its expected value. The system can optionally display to the user some or all of the root causes ranked according to the extent to which they ‘explain’ or correlate with the deviation of the performance measure from its expected value. Optionally, the user of the present invention can designate the root causes as more significant or less significant, and the user's input can he applied to modify or update the statistical relationship of the root cause with respect to the operational performance measure.

For convenience of illustration, the set of root causes related to a given performance measure can be divided into two groups, related metrics and sub populations. Related metrics are simply measures which are believed to be causative of deviations in a target operational performance metric, while sub-populations are arbitrary groupings of the data points constituting the operational performance metric which themselves deviate significantly from their expected value.

The extent to which a given related metric root cause explains or correlates with or the deviation of the operational performance measure is arrived at using common statistical techniques. (‘Correlate’ is used in this description and in the claims to refer generally to a statistical relationship, the value of which can be derived by various methods known to those of ordinary skill in the art, and is not limited to the derivation of a correlation coefficient except where specifically noted.) First, the historical relationship between the related metric and the operational performance measure is ascertained via a regression analysis or a causal inference method. This analysis results in a relationship (linear or non-linear mathematical transformation), which reflects the historical influence of the related metric on the operational performance measure. Next, in a manner analogous to the generation of an expected value for each operational performance measure, the value of each related metric potentially relevant to a given operational performance measure is calculated during the reference time period, and that calculation is compared against a reference value for that related metric. Once again, this reference value may be a historical value, an expected value that is derived from relevant exogenous factors, or a simple target value. The resulting difference is a value representing the difference between the related metric and a reference value for that metric. This difference for each related metric from its reference value then undergoes the previously determined mathematical transformation to arrive at value which represents the amount of deviation in the operational performance metric which can be explained by that particular related metric. Those related metrics which—due to their own deviation from expected values and their respective weights—result in the largest explained deviation of the target performance metric from its expected value are determined and optionally displayed as sorted list ranked. according to the extent to which the difference value correlates with or ‘explains’ the deviation of the target operational performance measure from its expected value.

The other group of potential root causes—sub-populations—are evaluated through an iterative process of selection, difference evaluation, and ranking. First, the sub-populations must be selected. Within each operational metric are a number of data points which constitute that metric; for example, the metric ‘Admitted Patient's Length of Stay’ is comprised of a number of patients which make up the calculation sample. The possible subgroupings for the sample includes as many unique traits as the individual data points in the sample may contain. For example, a sample of patients comprising ‘Admitted Patient's Length of Stay’ may share a number of characteristics such as the physician who treated them, the time of clay in which they arrived at the hospital, and other such attributes. The system enumerates every unique instance of such an attribute, including an attribute which denotes whether the data. point was in a statistically unlikely portion of the distribution (an outlier), The systems then calculates the value of the operational performance metric exclusively for the set of data points which share each unique attribute. Each calculated value is then compared against the expected value for that same grouping of data points using standard statistical methods. The difference, or deviation of the subgrouping from its expected value, is used to weight the effect of the grouping on the overall population. The resulting value can be thought of as the deviation in the operational performance metric which can be attributed to data points having a particular attribute in common.

Finally, the system determines a set of possible root causes—which includes both related metrics and sub-populations. These root causes are optionally sorted and displayed according to the magnitude of the deviation of the operational performance metric which they have been calculated to explain. Additionally, each of these explanations may be displayed with a visual signal that corresponds to the deviation explained, thereby allowing users to quickly and easily ascertain which root causes are the most significant.

In general, the system of the present invention enables the analysis of medical operational performance information in a novel way to ascertain those factors that significantly influence deviations in operational performance from expected values.

### DESCRIPTION

In a farther illustration of the present invention, the system could be configured to process and analyze the operational performance measure ‘Cost per Unit of Service.’ ‘Cost per Unit of Service’ is the expense of a treatment facility with regard to each patient and can be measured in dollars per patient day. When the metric is high, it suggests that too much staffing is being used in comparison to the patient load and/or that the cost of staffing is unusually high.

The user of the system can view the ‘Cost per Unit of Service’ metric by selecting it from the user interface of the system, which will display the metric and its expected value over a given time period (e.g., a week or a month). The user can then select a particular day and initiate a root cause analysis with regard to the ‘Cost per Unit of Service’ metric. The ‘root cause’ factors analyzed by the system according to the analytical framework described above may include, for example, the number of overtime hours worked, the ratio of ‘in house’ staff hours worked versus ‘agency’ staff (in-house staff typically being less costly), a measure of the number of non-productive hours in the time period (e.g., staffing that did not contribute directly to patient care, such as staff training). The statistical evaluation of the potential root causes may determine, for example, that one or more potentially related metrics, like the number of overtime hours, was unusually high and/or that the number of scheduled shifts on that day was lower than usual. These two root causes would suggest that the hospital was understaffed and incurred cost backfilling that demand with Overtime workers.

With regard to sub-populations, the root cause analysis system could also process all of the individual data points constituting ‘Cost per Unit of Service,’ i.e., all the shifts clocked by staff during the period, to find subgroups (if any) of these data points that explain the broader deviation. For example, the system could find that ‘Cost per Unit of Service’ for staff in one particular department, such as the surgical unit, were significantly higher than the others and exerted disproportionate influence on the target operational performance measure, and perhaps that shifts in the afternoon tended to have much higher ‘Cost per Unit of Service’ than other shifts. In this case, the user is presented with information that one department and one shift within that department are responsible for the observed hospital-wide increase in ‘Cost per Unit of Service.’

### BRIEF DESCRIPTION OF THE DRAWINGS

A more complete and thorough understanding of the present embodiments and advantages thereof may be acquired by referring to the following description taken in conjunction with the accompanying drawings, wherein:

FIG. 1 is a view of the user interface of an embodiment of the present invention.

FIG. 2 is a view of the user interface of an embodiment of the present invention showing the output after a root cause analysis has been performed with regard to selected dates.

FIG. 3 is a diagram of the information flow for an embodiment of the present invention.

### DETAILED DESCRIPTION OF THE DRAWINGS

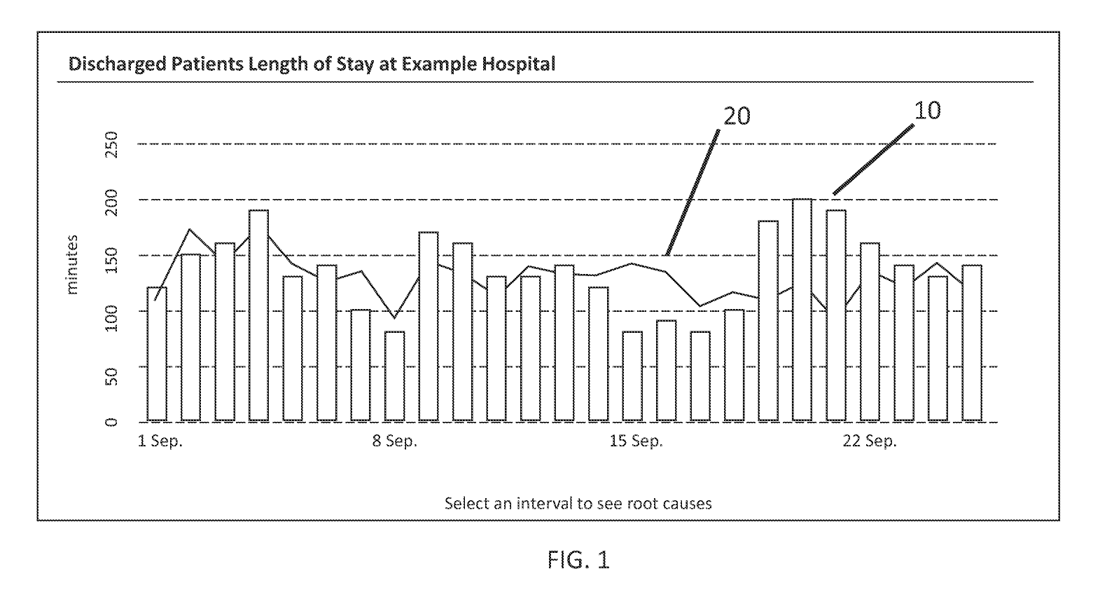

The user interface of an embodiment of the present invention is illustrated in FIG. 1, which displays information concerning the operational performance metric ‘Discharged Patients Length of Stay’ for the time period of September. The actual values of the metric are represented as a bar graph, with each outlined bar 10 indicating the average length of stay for patients on a given day. The actual values of the metric are represented against a line graph 20 displaying the expected values for the metric.

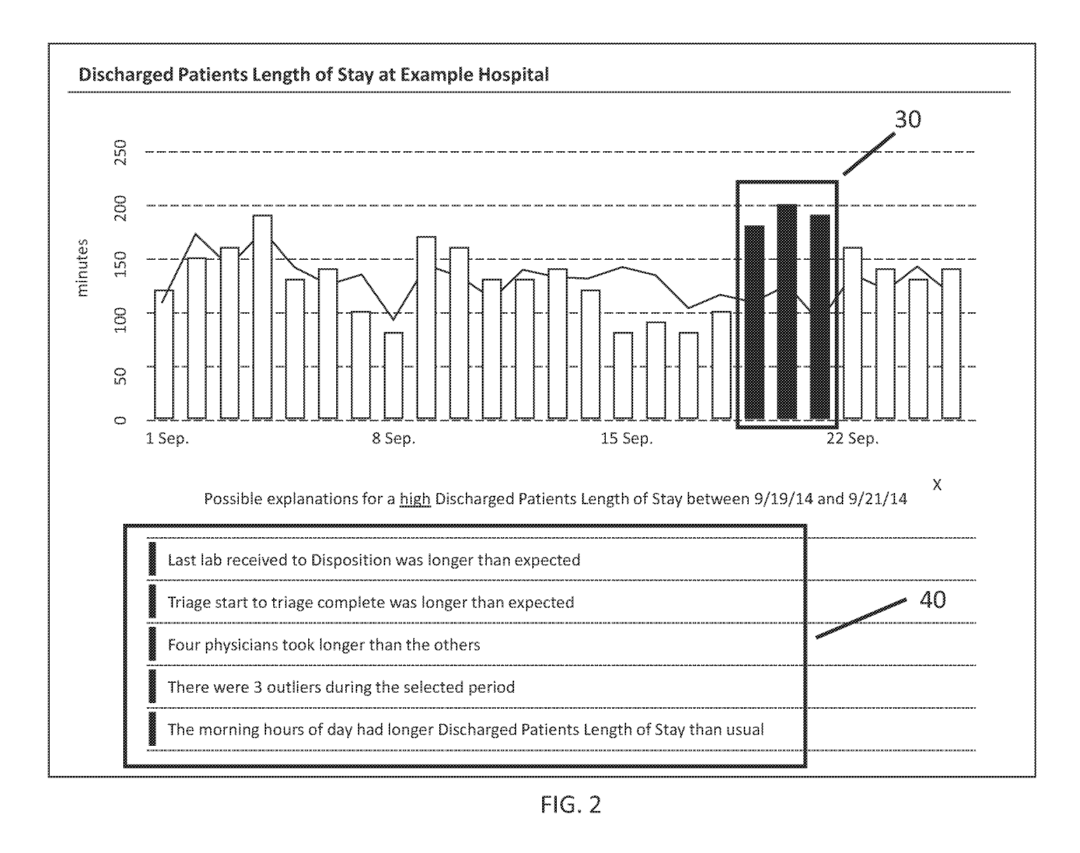

FIG. 2 displays the result of a root cause analysis performed by the present invention for three user-selected days, Sep. 19, 2014 to Sep. 21, 2014. The user selects one or more days of interest 30 and instructs the system to perform a root cause analysis. The system then performs the analysis and displays, in this embodiment, the five root causes 40 most likely responsible for the discrepancy between the actual and expected values for the metric.

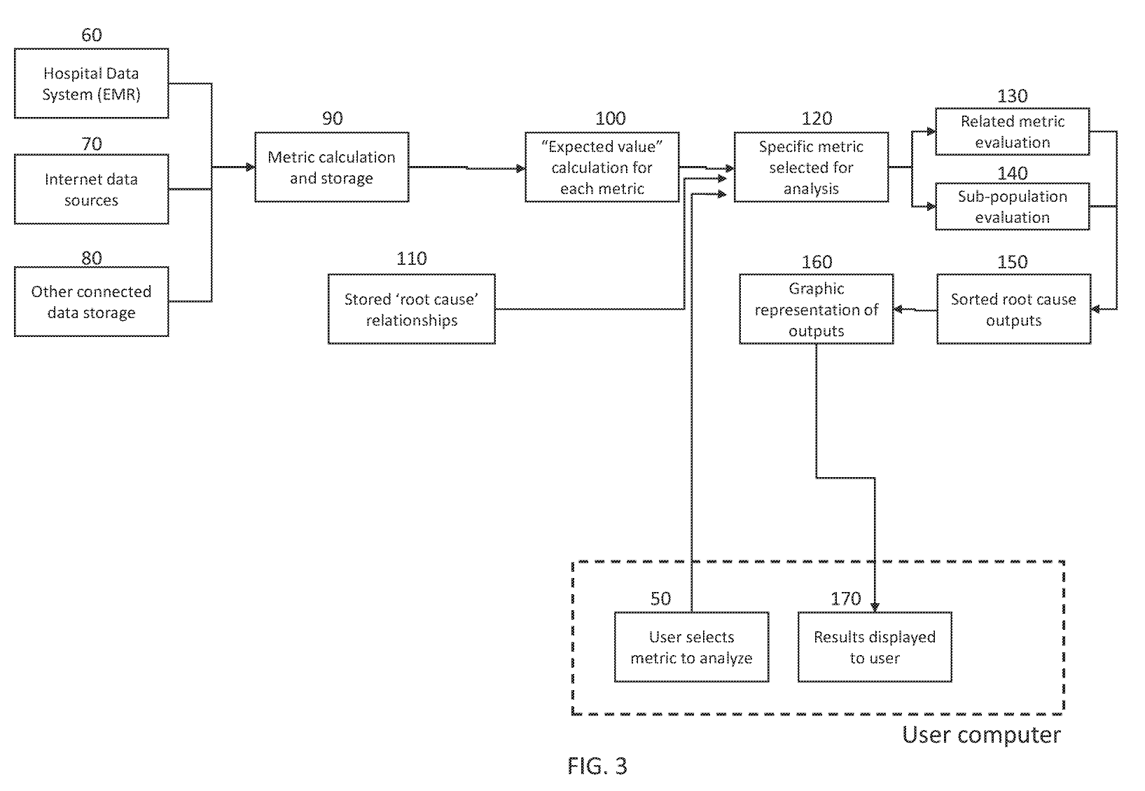

FIG. 3 is a diagram of the operational flow of an embodiment of the present invention. in this embodiment, the user selects the operational performance metric to analyze 50 using a standard internet browser. Depending on the specific metric selected, the data necessary to calculate its actual value, expected value, and the value of potential root causes is drawn from one or more sources, including the Hospital Data System 60, Internet data sources 70, or other connected data storage 80. Data from these sources is used to calculate the actual 90 and expected value 100 of the metric of interest. The system stores 110 or calculates the historical statistical relationship of potential ‘root cause’ metrics on the operational performance metric being analyzed 120. The influence of potential root causes, including related metrics 130 and sub-populations 140, can then be analyzed to determine a ranked list of potential root causes 150, which are graphically represented 160 and displayed to the user 170.

By aggregating and processing a broad set of potentially relevant data with regard to a given operational performance measure, the system enables the user to address the underlying factors or root causes affecting that performance measure. That is, not only are the results of the root cause analysis arrived at rapidly, they can also be shared with team members (e.g., by emailing or texting the results of the analysis or the location of a URL where the results are stored) and acted upon without undue delay. Additionally, the root cause analysis framework of the system of the present invention can identify unexpected factors or causes that would t have been evident in traditional analysis. By harnessing improvements in data capture, storage, and analysis the system of the present invention allows for the more efficient and effective provision of medical care and treatment.

Embodiments of this invention may be implemented via software in a standard computing environment (e.g., processor, operating system, local or remote data storage for input and output, network interface(s), display device(s)). The electronic devices associated with the system include devices in fixed locations and/or wireless devices, which may be mobile. The electronic devices selectively communicate with each other and with centralized electronic devices, including servers.

The software and electronic devices are referred to collectively as a “system.” It will be apparent to one of skill in the art that, although certain types of devices are described, many other types are appropriate for implementing embodiments of this invention. For example, embodiments of this invention may use wireless technology, hand held computers or ‘smart’ devices, networking and storage in one or more database(s) to facilitate or perform various claimed functions.

Modifications and substitution by one of ordinary skill in the art are considered to be within the scope of the present invention, which is not limited except by the following claims.

What is claimed is:

1. A system for analyzing medical operational performance information comprising:
defining a set of operational performance metrics relevant to a medical treatment setting,
determining the value of one or more members of the set of operational performance metrics based on information from one or more data sources,
determining an expected value for the operational performance metric, associating a set of potential correlational factors or root causes with each operational performance metric; and
determining the significance of the correlational factors or root causes on the deviation of the operational performance metric from its expected value by applying standard statistical methods.

2. The system of claim 1 further comprising displaying a list of one or more correlational factors or root causes according to their significance with respect to the deviation of said operational performance metric from its expected value.

3. The system of claim 1 further comprising automatically associating a set of potential correlation factors or root causes with each operational metric though regression analysis or a causal inference method for a set of potential root causes.

4. The system of claim 1 where the potential correlational factors or root causes are populated by data from electronic medical records.

5. The system of claim 2 further comprising the ability to communicate the list via electronic mail or other form of electronic messaging.

6. The system of claim 2 further comprising the ability to incorporate user feedback into the ranking of said correlation factors or root causes.

7. The system of claim 2 further comprising the ability to transmit the results back into a hospital data system or electronic medical records.

8. The system of claim 6 where the user feedback involves the user designating one or more correlation factors or root causes as more significant or less significant and modifying the weight of the correlation factor or root cause accordingly.

9. A method for analyzing medical operational performance information comprising:
defining a set of operational performance metrics relevant to a medical treatment setting,
determining the value of one or more members of the set of operational performance metrics based on information from one or more data sources,
determining an expected value for the operational performance metric,
associating a set of potential correlational factors or root causes with each operational performance metric; and
determining the significance of the correlational factors or root causes on the deviation of the operational performance metric from its expected value by applying standard statistical methods.

10. The method of claim 9 further comprising displaying a list of one or more correlational factors or root causes according to their significance with respect to the deviation of said operational performance metric from its expected value.

11. The method of claim 9 further comprising automatically associating a set of potential correlation factors or root causes with each operational metric though regression analysis or a causal inference method for a set of potential root causes.

12. The method of claim 9 where the potential correlational factors or root causes are populated by data from electronic medical records.

13. The method of claim 10 further comprising the ability to communicate the list via electronic mail or other form of electronic messaging.

14. The method of claim 10 further comprising the ability to transmit the results back into a hospital data system or electronic medical records.

15. The method of claim 10 further comprising the ability to incorporate user feedback into the ranking of said correlation factors or root causes.

16. The method of claim 15 where the user feedback involves the user designating one or more correlation factors or root causes as more significant or less significant and modifying the weight of the correlation factor or root cause accordingly.
